(19) United States
(12) Patent Application Publication
(10) Pub. No.: US 2026/0119629 A1
(43) Pub. Date: Apr. 30, 2026

(54) BIOMETRIC-BASED INITIALIZATION OF DEVICE RANGING FOR DIGITAL KEY EXCHANGE

(71) Applicant: Motorola Mobility LLC, Chicago, IL (US)

(72) Inventors: Ranjeet Gupta, Aurora, IL (US); Michael E. Russell, Lake Zurich, IL (US)

(73) Assignee: Motorola Mobility LLC, Chicago, IL (US)

(21) Appl. No.: 18/930,752

(22) Filed: Oct. 29, 2024

(51) Int. Cl. G06F 21/32; G06F 21/62

(52) U.S. Cl. CPC G06F 21/32; G06F 21/62

(57) ABSTRACT

In aspects of biometric-based initialization of device ranging for digital key exchanges, authentication data is received during a touch event via a fingerprint sensor of a mobile device. The authentication data can be associated with a fingerprint that has previously been associated with a digital key for a secured area. In another example, the authentication data can be associated with a fingerprint associated with unlocking the mobile device and received while the mobile device is unlocked. Based on a successful authentication of the authentication data, the mobile device performs device ranging in association with a digital key exchange with the secured area.

### BACKGROUND

With the advancement of technology, electronic devices have become a common part of our daily lives. For example, many people carry cell phones and smartwatches throughout the day. These electronic devices can serve as digital keys, providing passive access to various devices and spaces such as lockers, home security systems, and automobiles. However, when the user is near the protected area (e.g., in a garage near their parked vehicle), the electronic devices repeatedly attempt to unlock the protected area even if the user does not intend to access it. The repeated and unnecessary attempts to provide passive entry leads to accidental unlocking and drainage of the electronic device's battery.

### BRIEF DESCRIPTION OF THE DRAWINGS

Aspects of biometric-based initialization of device ranging for digital key exchange are described with reference to the following Figures. The same numbers may be used throughout to reference similar features and components that are shown in the Figures. Further, identical numbers followed by different letters reference different instances of features and components described herein:

FIG. 1 illustrates an example environment in which aspects of biometric-based initialization of device ranging for digital key exchanges can be implemented;

FIG. 2 depicts an example system in which aspects of biometric-based initialization of device ranging for digital key exchanges can be implemented;

FIG. 3 depicts an example flow diagram in which aspects of biometric-based initialization of device ranging for digital key exchanges can be implemented using a dedicated fingerprint;

FIG. 4 depicts an example flow diagram in which aspects of biometric-based initialization of device ranging for digital key exchanges can be implemented using a general fingerprint;

FIG. 5 depicts an example procedure for biometric-based initialization of device ranging for digital key exchanges in accordance with one or more implementations; and

FIG. 6 illustrates various components of an example electronic device that can implement embodiments of the techniques described herein.

### DETAILED DESCRIPTION

Biometric-based initialization of device ranging for digital key exchanges is discussed herein. Digital key technology allows users to securely and conveniently access devices (e.g., smartphones, laptops, automobiles) or spaces (e.g., lockers, homes, elevators, business offices) using digital credentials or keys stored on electronic devices rather than using traditional physical keys, key cards, or fobs. A digital key includes a unique code or data set for accessing the protected area and is generally linked to a specific user or electronic device. The digital key is stored securely on the user's electronic device. When the user approaches the protected area equipped with digital key technology, the protected area requests that the user's electronic device provide the digital key. Upon verifying the authenticity and validity of the digital key, the user is granted access to the protected area.

However, in several frequent scenarios, the user or the user's electronic device is near the protected area when the user does not intend to enter the protected area. For example, the user is working in or passing through their garage where their vehicle is parked, roaming (e.g., mowing the grass or chatting with neighbors) in their front lawn, sitting in a room near the garage or driveway, or sitting next to the protected area. In these situations, the electronic device enters an active ranging mode to accurately determine the distance between the digital key (e.g., the user's electronic device) and the receiver (of the protected area), unnecessarily draining the electronic device's battery. If the digital key is near enough to the receiver, the protected area will be unlocked (or repeatedly unlocked as the user enters and leaves the threshold range), potentially creating security concerns by accidental unlocks.

To address these problems, the described techniques and systems for biometric-based initialization of device ranging for digital key exchanges avoids these common issues. For instance, an electronic device typically includes user authentication capability to request authentication information before a user is granted access to functionality of the electronic device. Because many modern devices include biometric sensors (e.g., fingerprint scanners) which collect biometric information for use in authenticating a user, the proposed techniques utilize this user authentication capability to infer a user's intent to use their stored digital key and access a protected area. The electronic device associates a specified or repeated biometric template with digital key services. Once the electronic device authenticates the user with the specified or repeated biometric template (e.g. fingerprint), then the electronic device performs device ranging and passive unlocking. In this way, the electronic device avoids unnecessary battery drainage from repeated ranging attempts and unwanted unlocking.

While features and concepts of the described techniques for biometric-based initialization of device ranging for digital key exchanges can be implemented in any number of different devices, systems, environments, and/or configurations, implementations of the techniques and systems for biometric-based initialization of device ranging for digital key exchanges s are described in the context of the following example devices, systems, and methods.

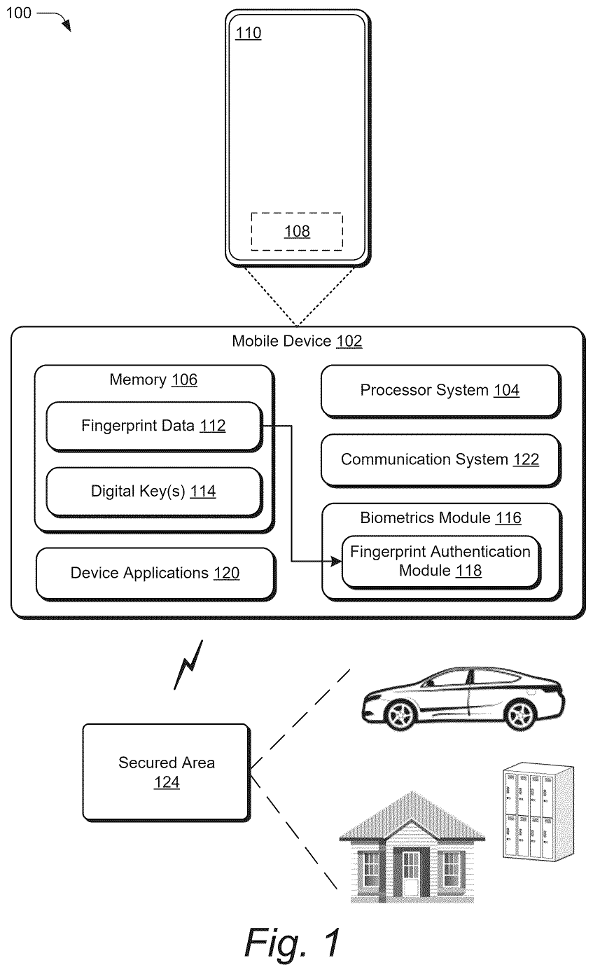

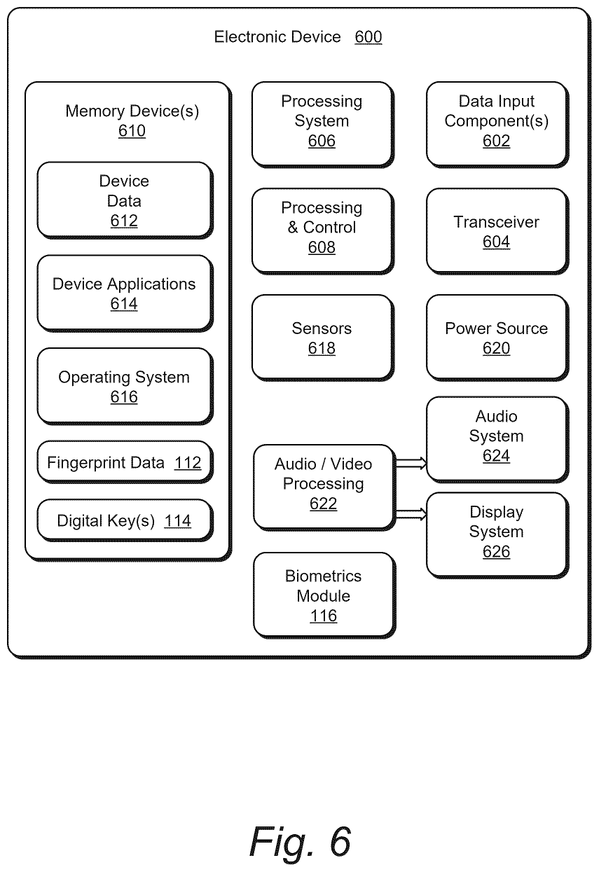

FIG. 1 illustrates an example environment 100 in which aspects of biometric-based initialization of device ranging for digital key exchanges can be implemented. The environment 100 includes a mobile device 102, which may be any type of mobile phone, smartphone, flip phone, computing device, tablet device, smartwatch, and/or any other type of mobile device. Generally, the mobile device 102 may be any electronic, computing, and/or communication device implemented with various components, such as a processor system 104 and memory 106, as well as any number and combination of different components as further described with reference to the example device shown in FIG. 6.

The mobile device 102 includes a fingerprint sensor 108, which when touched, collects data describing a fingerprint of a user that can be used to authenticate the user. In one or more implementations, the fingerprint sensor 108 is an under-display fingerprint sensor in which a display 110 is a topmost layer of the mobile device 102, and the fingerprint sensor 108 is located in between the display 110 and a back housing of the mobile device 102. As shown, the fingerprint sensor 108 is illustrated as a rectangular strip, however, it is to be appreciated that the size and shape of the fingerprint sensor 108 can vary. In additional or alternative implementations, the fingerprint sensor 108 is an integrated component of the display 110 rather than located underneath the display 110. Additionally or alternatively, the fingerprint sensor 108 is an integrated component of a front housing of the mobile device 102 proximate the display 110, and as such, is not a component of the display 110. It is to be appreciated that the fingerprint sensor 108 can be any type of fingerprint sensor, including but not limited to an optical fingerprint sensor, a capacitance fingerprint sensor, an ultrasonic fingerprint sensor, a thermal fingerprint sensor, etc. Further, the display 110 represents functionality (e.g., hardware and logic) for enabling visual output of content by the mobile device 102 (e.g., via a user interface), and in various implementations, the display 110 is a touch-sensitive display, enabling receipt of touch inputs via the display 110.

The memory 106 is illustrated as maintaining known fingerprint data 112, which is fingerprint data associated with a user that is authorized to access functionality and content of the mobile device 102. Broadly, when access to secure content and/or secure functionality of the mobile device 102 is requested (e.g., a user attempts to unlock the mobile device 102 or access a secure device application), fingerprint data is collected via the fingerprint sensor 108 and compared to the known fingerprint data 112. If the collected fingerprint authentication data matches the known fingerprint data 112, then access to the requested content and/or requested functionality is granted. The known fingerprint data 112 includes fingerprint data associated with any number of users authorized to access the functionality and content of the mobile device 102. In at least one implementation, the known fingerprint data 112 includes, for each of the users that are authorized to access the functionality and content of the mobile device 102, multi-fingerprint data associated with multiple fingers of each of the users. By way of example, the memory 106 includes known fingerprint data 112 associated with a right thumb, a left thumb, a right pointer finger, a left pointer finger, a right middle finger, a left middle finger, and so on, of a respective user of the mobile device 102.

The memory 106 is further illustrated as including one or more digital keys 114, which are software-based electronic representations of traditional physical keys for a secured area 124 (e.g., an automobile, locker, or home security system). In other implementations, the digital keys 114 are stored in a secure element, which may be separate from the general memory of the mobile device 102. For example, the secure element can be an embedded secure element (eSE), which is a tamper-resistant hardware device, such as a smart card chip that includes its own integrated processor, memory (e.g., ROM, EEPROM, RAM), and an I/O port for tamper-proof connectivity and data communication with other hardware devices implemented in the mobile device 102.

The digital keys 114 are stored in the memory 106 and can be in the form of secured application data, digital certificates, or tokens. Each digital key 114 includes a unique identifier distinguishing it from other digital keys 114 for the same secured area 124. By way of example and not limitation, the secured area 124 includes an automobile, locker, home security system, electronic device (e.g., computer or server), hotel room, office security system, and so on. The mobile device 102 or a device application 120 associated with the secured area 124 uses a digital key 114 to unlock or permit access to the secured area 124.

The mobile device 102 also includes a biometrics module 116, which includes a fingerprint authentication module 118. The biometrics module 116 is hardware, software, or combination thereof in the mobile device 102 to authenticate users based on unique physical characteristics to enhance security and provide convenient access to the mobile device 102 and device applications 120. Common types of biometrics used by the biometrics module 116 includes fingerprints, facial recognition, voice recognition, and/or iris recognition. In the illustrated implementation of mobile device 102, the biometrics module 116 utilizes the fingerprint authentication module 118 to manage access rights.

The fingerprint sensor 108 collects authentication data during a touch event. The authentication data associated with the touch event is provided to the fingerprint authentication module 118, which attempts to authenticate the authentication data. The fingerprint authentication module 118 compares the authentication data to the known fingerprint data 112. If a match is found in the known fingerprint data 112, then the fingerprint authentication module 118 outputs a successful authentication of the touch event.

The mobile device 102 also includes one or more device applications 120 and communication system(s) 122. The device applications 120 are software applications designed to exchange or send (e.g., using the communication system 122) the digital key 114 associated with a particular secured area 124 to a receiver of an electronic device associated with the secured area 124. Upon authentication and verification of the digital key 114, the secured area 124 is unlocked or otherwise permits access to a user of the mobile device 102.

The communication system 122 includes communication transceivers that enable wireless communication of the digital keys 114 with other devices (e.g., associated with the secured area 124). Example transceivers include wireless personal area network (WPAN) radios compliant with various IEEE 802.15 (Bluetooth™) standards, wireless radios compliant with various IEEE 802.15.4 (Ultra-Wideband™) standards wireless local area network (WLAN) radios compliant with any of the various IEEE 802.11 (WiFi™) standards, wireless wide area network (WWAN) radios for cellular phone communication, wireless metropolitan area network (WMAN) radios compliant with various IEEE 802.15 (WiMAX™) standards, wired local area network (LAN) Ethernet transceivers for network data communication, and cellular networks (e.g., third generation networks, fourth generation networks such as LTE networks, or fifth generation networks).

Conventional techniques for exchanging digital keys 114 involve the mobile device 102 using the communication system 122 to perform range scanning to determine the distance between the mobile device 102 and the secured area 124. In some implementations, the range scanning is performed periodically or in response to detecting user steps to obtain an initial separation distance. This initial ranging is often performed using Bluetooth Low Energy™ (BLE) or Wi-Fi™ signals (e.g., via received signal strength indicator (RSSI) signals). When the separation distance is determined to be below a first threshold distance (e.g., 10 meters), the conventional techniques trigger fine timing measurements (FTM) via UWB to improve the ranging accuracy. UWB ranging continues until the separation distance is below a second threshold distance (e.g., several meters), which triggers the secured area 124 (e.g., a vehicle) to unlock. As described above, these conventional techniques result in unnecessary and unattended UWB ranging and unlocking of the secured area 124 in many scenarios, resulting in extra battery usage and potential security concerns.

In accordance with the described techniques, UWB ranging and the exchange of digital keys 114 is triggered by biometrics authentication. Without the below described user authentication, the UWB ranging and digital key exchange is not triggered, preventing unwanted battery usage and unlocking. In one implementation, the biometrics authentication to initiate the digital key change process is associated with a particular finger or fingers of the user. In another implementation, the biometrics authentication is associated with any finger of the user and a second biometrics attestation (e.g., after the mobile device 102 is unlocked by a first biometrics attestation) initiates the digital key exchange with UWB ranging.

Having discussed an example environment in which the disclosed techniques can be performed, consider now some example scenarios and implementation details for implementing the disclosed techniques.

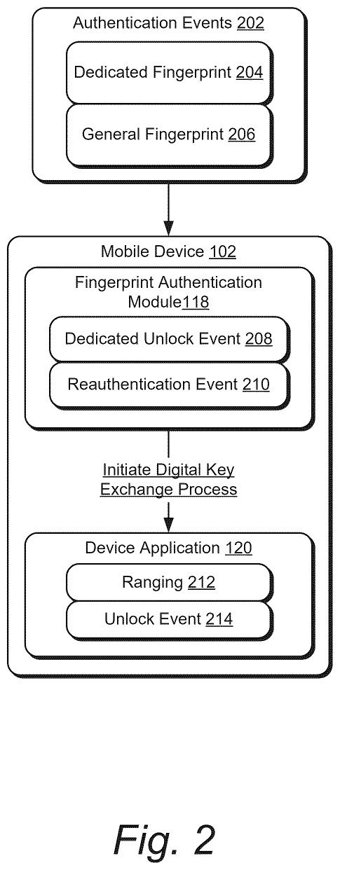

FIG. 2 depicts an example system 200 in which aspects of biometric-based initialization of device ranging for digital key exchanges can be implemented. By way of example, the fingerprint sensor 108 receives authentication events 202 including a dedicated fingerprint 204 and a general fingerprint 206. Although illustrated as including a single fingerprint, it is to be appreciated that authentication events 202 can include fingerprints of multiple fingers or another biometric input (e.g., face recognition, iris recognition, voice recognition).

The dedicated fingerprint 204 is associated with a finger specifically enrolled by the user of the mobile device 102 to initiate the digital key exchange process with one or more secured areas 124. In other words, the dedicated fingerprint 204 is associated with the digital key service for a particular secured area 124. For example, the user may enroll multiple fingers (e.g., left thumb, right thumb, and right index finger) to unlock the mobile device 102 but associates one or more specific fingers (e.g., left or right pinky finger) with passively unlocking their vehicle. In contrast, the general fingerprint 206 is generally used by the mobile device 102 to authenticate the user for unlocking the device and/or granting access to one or more device applications 120 (e.g., a banking application).

As described above, common types of biometrics used by the biometrics module 116 includes fingerprints, facial recognition, voice recognition, and/or iris recognition. In one example, the dedicated fingerprint 204 can be a left pinky finger associated with the user's vehicle and a right pinky finger associated with the user's home security system. In this example, the left pinky finger can be used to unlock the mobile device 102 and initiate the digital key exchange with the user's vehicle, but the left pinky finger will not initiate the digital key exchange with the user's home security system. Continuing this example, the user can associate other fingers (e.g., the left thumb) with general biometric access to the mobile device 102 or applications 120, but not with the digital key exchange with the user's vehicle or home security system.

In another example, the user can enroll one or more fingers as the general fingerprint 206 and use another biometric input (e.g., face, voice, or iris) as the dedicated fingerprint 204. In this way, the user uses their face as the dedicated fingerprint 206 to unlock the mobile device 102 and initiate the digital key exchange with the secured area 124. However, if the user uses a general fingerprint 206 to unlock the mobile device 102, the digital key exchange will not be initiated in this example. It is appreciated that different combinations of biometrics can be used for the dedicated fingerprint 204 and/or the general fingerprint 206 within the spirit of the described techniques and systems.

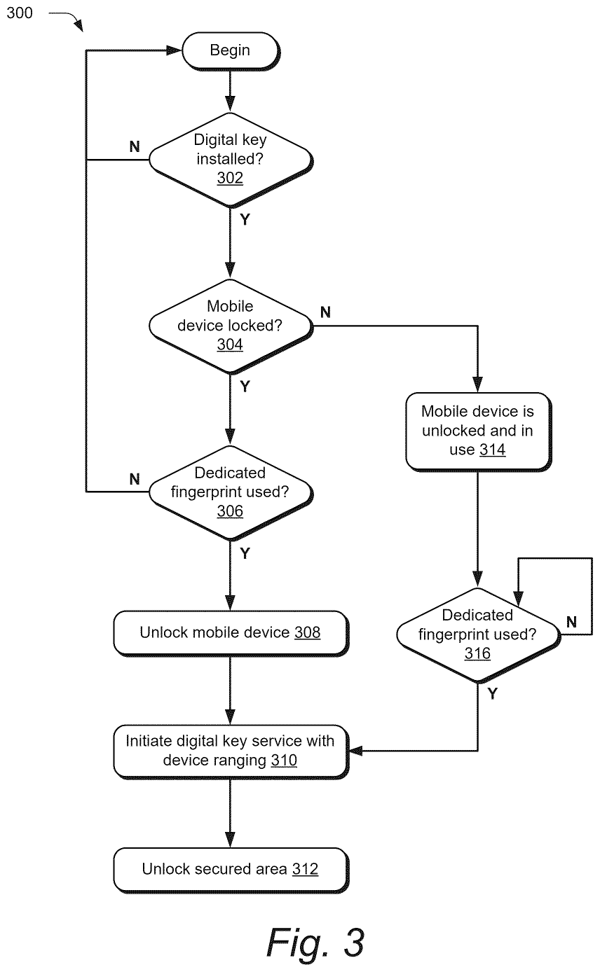

The fingerprint authentication module 118 receives the authentication event 202 and determines whether the received event represents a dedicated fingerprint 204 or a general fingerprint 206. In one implementation, if the authentication event 202 includes a dedicated fingerprint 204, the fingerprint authentication module 118 initiates a dedicated unlock event 208, which triggers ranging 212 by a device application 120 associated with the secured area 124. In other words, the dedicated unlock event 208 unlocks the mobile device 102 and/or initiates the device ranging 212 (e.g., via a UWB transceiver). In this way, the mobile device 102 receives a reliable indication of the user's intent to access the secured area 124 associated with the dedicated fingerprint 204 before initiating the digital key exchange process with ranging 212 and an unlock event 214. Accordingly, the digital key exchange is sandboxed or isolated from general fingerprints. The dedicated unlock event 208 is described in more detail with respect to FIG. 3.

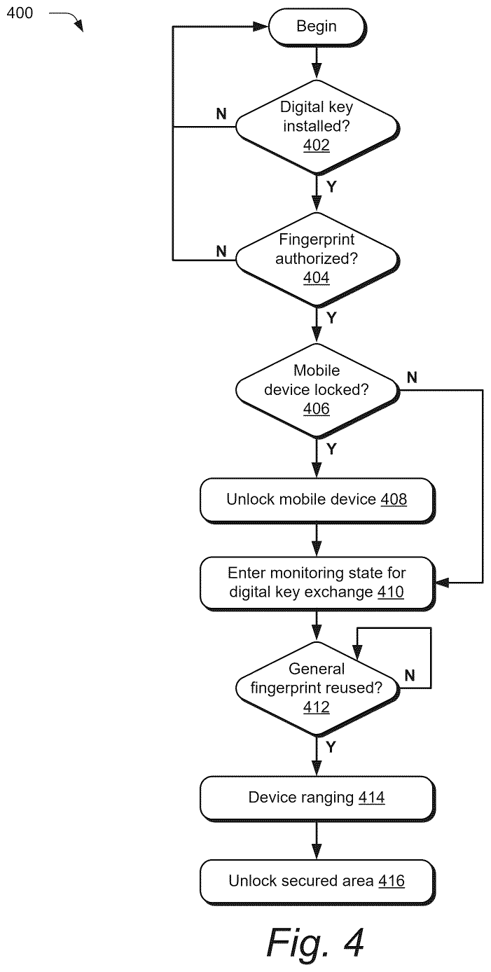

In another implementation and in response to receiving the authentication event 202, the fingerprint authentication module 118 determines whether it represents a reauthentication event 210. The reauthentication event 210 is implemented in addition to or in lieu of potential dedicated unlock events 208. When a general fingerprint 206 is received during a locked state of the mobile device 102, the fingerprint authentication module 118 uses the general fingerprint 206 to unlock mobile device 102. If the general fingerprint 206 is received during an unlocked state, the fingerprint authentication module 118 initiates a reauthentication event 210, which triggers ranging 212 by a device application 120 associated with the secured area 124. The second attestation or authentication via the general fingerprint 206 indicates the user's intent to access the secured area 124, triggering the ranging 212 and unlock event 214. Accordingly, in this implementation, the digital key exchange is sandboxed or isolated until the second attestation occurs with the general fingerprint 206. The reauthentication event 210 is described in more detail with respect to FIG. 4.

FIG. 3 depicts an example flow diagram 300 in which aspects of biometric-based initialization of device ranging for digital key exchanges can be implemented using a dedicated fingerprint. At 302, it is determined whether a digital key is installed or saved (e.g., in a secure or trusted memory environment) in a mobile device. By way of example, the mobile device 102 or one or more device applications 120 determine whether a digital key 114 is installed or saved on the mobile device 102. In response to a digital key 114 not being installed on the mobile device 102 (e.g., a “no” determination at block 302), the mobile device 102 or device application 120 returns to the beginning of the flow diagram 300. In one implementation, the flow diagram 300 does not initiate block 302 until a digital key is installed on the mobile device 102.

At 304, in response to a digital key being installed on the mobile device (e.g., a “yes” determination at block 302), it is determined whether the mobile device is locked. By way of example, the mobile device 102 or a device application 120 determines whether the mobile device is locked (e.g., in a locked state with limited access available to the user).

At 306, in response to the mobile device being locked (e.g., a “yes” determination at block 304), it is determined whether the user has used a dedicated fingerprint to unlock the mobile device. By way of example, the fingerprint sensor 108 determines whether a dedicated fingerprint 204 was received as part of an authentication event 202. As described above, the dedicated fingerprint 204 is one or more specific fingers (e.g., a pinky finger) that the user has associated with unlocking a particular secured area 124 (e.g., the user's vehicle). In response to a dedicated fingerprint not being used as part of an authentication event 202 (e.g., a “no” determination at block 306), the mobile device 102 or device application 120 returns to the beginning of the flow diagram 300. In another implementation, the mobile device 102 or device application 120 returns to block 304 and awaits another authentication event.

At 308, in response to the dedicated fingerprint being used (e.g., a “yes” determination at block 306), the mobile device is unlocked. By way of example, the dedicated fingerprint 204 is used by the fingerprint authentication module 118 to unlock the mobile device 102. At 310, the mobile device 102 or device application 120 then initiates the digital key exchange process by performing device ranging using an UWB transceiver, Bluetooth channel sounding, or another ranging technique. At 312, the secured area is unlocked. By way of example, once the mobile device is within a distance threshold of the secured area, the UWB or NFC transceiver transmits the digital key 114 to a receiver associated with the secured area 124 and, in response to authenticating and verifying the digital key 114, unlocks or grants access to the secured area 124.

At 314, in response to the mobile device not being locked (e.g., a “no” determination at block 304), it is determined that the mobile device is unlocked and in use. By way of example, the user previously unlocked the mobile device 102 using a general fingerprint 206.

At 316, it is determined whether the user has entered a dedicated fingerprint to the fingerprint sensor. By way of example, the fingerprint sensor 108 determines whether a dedicated fingerprint 204 was received as part of a new authentication event 202. As described above, the dedicated fingerprint 204 is one or more specific fingers (e.g., a pinky finger) that the user has associated with unlocking a particular secured area 124 (e.g., the user's vehicle). In response to a dedicated fingerprint not being used as part of the authentication event 202 (e.g., a “no” determination at block 316), the mobile device 102 or device application 120 periodically returns to block 316 or waits for another authentication event 202 before returning to block 316. In response to the dedicated fingerprint being used (e.g., a “yes” determination at block 316), the mobile device 102 or device application 120 proceeds to block 310 to initiate the digital key service with device ranging as described above.

FIG. 4 depicts an example flow diagram 400 in which aspects of biometric-based initialization of device ranging for digital key exchanges can be implemented using a general fingerprint. At 402, it is determined whether a digital key is installed or saved (e.g., in a secure or trusted memory environment) in a mobile device. By way of example, the mobile device 102 or one or more device applications 120 determine whether a digital key 114 is installed or saved on the mobile device 102. In response to a digital key 114 not being installed on the mobile device 102 (e.g., a “no” determination at block 402), the mobile device 102 or device application 120 returns to the beginning of the flow diagram 400. In one implementation, the flow diagram 400 does not initiate block 402 until a digital key is installed on the mobile device 102.

At 404, in response to a digital key being installed on the mobile device (e.g., a “yes” determination at block 402), it is determined whether the user has used an authorized fingerprint at the fingerprint sensor. By way of example, the fingerprint sensor 108 determines whether a general fingerprint 206 was received as part of an authentication event 202. As described above, the general fingerprint 206 is one or more fingers (e.g., a thumb) used to unlock the device and to generally authenticate the user's access to certain device applications 120.

In response to a general fingerprint not being used as part of an authentication event 202 (e.g., a “no” determination at block 404), the mobile device 102 or device application 120 returns to the beginning of the flow diagram 400. In another implementation, the mobile device 102 or device application 120 returns to block 402 and awaits another authentication event.

At 406, in response to the fingerprint being authorized (e.g., a “yes” determination at block 404), it is determined whether the mobile device is locked. By way of example, the mobile device 102 or a device application 120 determines whether the mobile device is locked (e.g., in a locked state with limited access available to the user). In response to the mobile device not being locked (e.g., a “no” determination at block 406), the mobile device 102 or device application 120 proceeds to block 410 (as described below).

At 408, in response to the mobile device being locked (e.g., a “yes” determination at block 406), the mobile device is unlocked. By way of example, the general fingerprint 206 is used by the fingerprint authentication module 118 to unlock the mobile device 102. At 410, the mobile device 102 or the device application 120 enters a monitoring state for a potential digital key exchange. By way of example, the monitoring state includes active observation and tracking of initiation of the digital key exchange process or transaction.

At 412, it is determined whether the user has reused the general fingerprint or another authorized fingerprint at the fingerprint sensor. By way of example, the fingerprint sensor 108 determines whether the general fingerprint 206 was received again as part of a new authentication event 202. In response to the general fingerprint not being reused as part of an authentication event 202 (e.g., a “no” determination at block 412), the mobile device 102 or device application 120 returns to block 412 periodically or upon initiating a new authentication event.

At 414, in response to the general fingerprint being reused as part of an authentication event (e.g., a “yes” determination at block 412), the mobile device 102 or device application 120 initiates the digital key exchange process by performing device ranging using an UWB transceiver or another ranging technique. At 416, the secured area is unlocked. By way of example, once the mobile device is within a distance threshold of the secured area, the UWB or NFC transceiver transmits the digital key 114 to a receiver associated with the secured area 124 and, in response to authenticating and verifying the digital key 114, unlocks or grants access to the secured area 124.

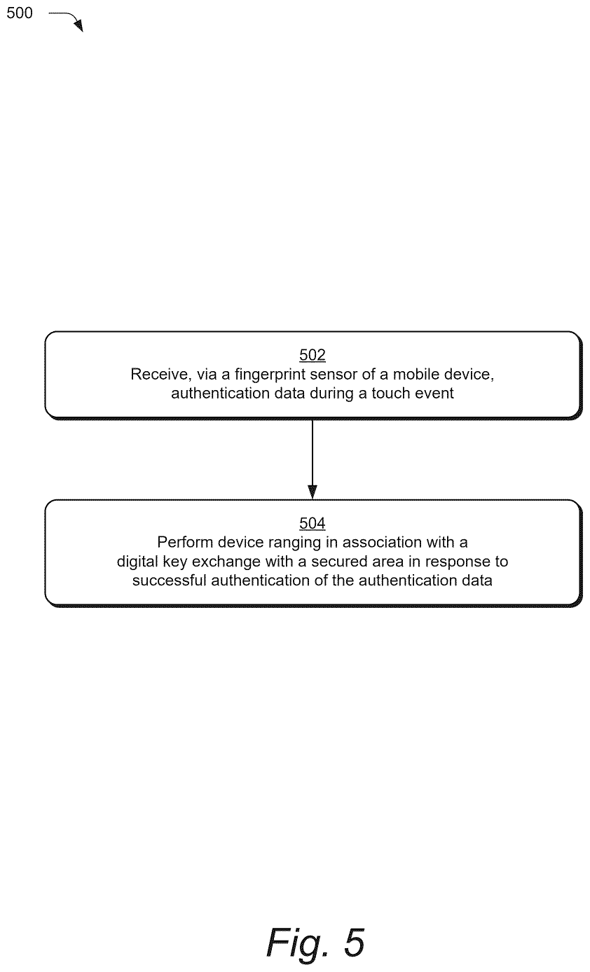

FIG. 5 depicts an example procedure 500 for biometric-based initialization of device ranging for digital key exchanges in accordance with one or more implementations. At 502, authentication data is received via a fingerprint sensor of a mobile device during a touch event. By way of example, the fingerprint sensor 108 receives authentication data during a touch event. The authentication data is associated with a finger. The fingerprint sensor 108 is integrated in the mobile device 102, which includes, for example, a smartphone, a mobile phone, or a smartwatch.

At 504, device ranging in association with a digital key exchange with a secured area is performed in response to successful authentication of the authentication data. By way of example, the mobile device 102 or one or more device applications 120 cause the communication system 122 to perform device ranging (e.g., using a UWB transceiver) to determine whether the mobile device 102 is sufficiently close to the secured area 124 (or a receiver thereof) to initiate the digital key exchange (e.g., transmit the digital key 114 for the secured area 124 to the receiver associated with the secured area 124). The secured area 124 includes, for example, an automobile, a lock, a locker, a security system, a hotel room, or a smart home device. In response to the device ranging indicating that the mobile device 102 is within a predetermined distance of the secured area 124 (or a receiver thereof), the mobile device 102 or the device application 120 causes the communication system 122 to transmit (e.g., using a UWB or NFC transceiver) the digital key 114 associated with the secured area 124 to a receiver associated with the secured area 124 to unlock or grant access to the secured area 124.

In a first exemplary implementation, the authentication data is associated with a particular finger (e.g., the dedicated fingerprint 204 of FIG. 2) that the user has associated with a particular secured area. In scenarios where the mobile device 102 is in a locked state, mobile device 102 enters an unlocked state (e.g., unlocks) and performs device ranging in association with the digital key exchange process for the particular secured area in response to successfully authenticating the dedicated fingerprint 204. In scenarios where the mobile device 102 is in an unlocked state, mobile device 102 initiates the device ranging in response to successfully authenticating the dedicated fingerprint 204. In some implementations, the touch event when the mobile device 102 is unlocked must last longer than a predetermined time threshold before the fingerprint sensor 108 receives the authentication data to determine whether or not the device ranging should be initiated. In this exemplary implementation, successful authentication of a general fingerprint 206 (e.g., a fingerprint not specifically associated with the particular secured area) can unlock the mobile device 102 but does not initiate the device ranging.

In a second exemplary implementation, the authentication data is associated with any registered finger (e.g., the general fingerprint 206 of FIG. 2) that the user has associated with unlocking the mobile device 102 and general biometric authorization. In scenarios where the mobile device 102 is in a locked state, mobile device 102 enters an unlocked state (e.g., unlocks) in response to successfully authenticating the general fingerprint 206. At this point, the mobile device 102 does not initiate device ranging. In scenarios where the mobile device 102 is in an unlocked state, mobile device 102 initiates the device ranging in response to successfully authenticating the general fingerprint 206. In some implementations, the touch event when the mobile device 102 is unlocked must last longer than a predetermined time threshold before the fingerprint sensor 108 receives the authentication data to determine whether or not the device ranging should be initiated.

FIG. 6 illustrates various components of an example electronic device that can implement embodiments of the techniques discussed herein. The electronic device 600 can be implemented as any of the devices described with reference to the previous Figures, such as any client device, mobile phone, tablet, computing, communication, entertainment, gaming, media playback, or other electronic device. In one or more embodiments, the electronic device 600 includes fingerprint data 112, digital keys 114, and biometrics module 116, as described above.

The electronic device 600 includes one or more data input components 602 via which any type of data, media content, or inputs can be received, such as user-selectable inputs, messages, music, television content, recorded video content, and any other type of text, audio, video, or image data received from any content or data source. The data input components 602 may include various data input ports such as universal serial bus ports, coaxial cable ports, and other serial or parallel connectors (including internal connectors) for flash memory, DVDs, compact discs, and the like. These data input ports may be used to couple the electronic device 600 to components, peripherals, or accessories such as keyboards, microphones, or cameras. The data input components 602 may also include various other input components such as microphones, touch sensors, touchscreens, keyboards, and so forth.

The device 600 includes communication transceivers 604 that enable one or both wired and wireless communication of device data with other devices (e.g., associated with a secured area). The device data can include the digital keys 114 or any text, audio, video, image data, or combinations thereof. Example transceivers include wireless personal area network (WPAN) radios compliant with various IEEE 802.15 (Bluetooth™) standards, wireless radios compliant with various IEEE 802.15.4 (Ultra-Wideband™) standards wireless local area network (WLAN) radios compliant with any of the various IEEE 802.11 (WiFi™) standards, wireless wide area network (WWAN) radios for cellular phone communication, wireless metropolitan area network (WMAN) radios compliant with various IEEE 802.15 (WiMAX™) standards, wired local area network (LAN) Ethernet transceivers for network data communication, and cellular networks (e.g., third generation networks, fourth generation networks such as LTE networks, or fifth generation networks).

The device 600 includes a processing system 606 of one or more processors (e.g., any of microprocessors, controllers, and the like) or a processor and memory system implemented as a system-on-chip (SoC) that processes computer-executable instructions. The processing system 606 may be implemented at least partially in hardware, which can include components of an integrated circuit or on-chip system, an application-specific integrated circuit (ASIC), a field-programmable gate array (FPGA), a complex programmable logic device (CPLD), and other implementations in silicon or other hardware.

Alternately or in addition, the device can be implemented with any one or combination of software, hardware, firmware, or fixed logic circuitry implemented in connection with processing and control circuits, which are generally identified at 608. The device 600 may further include any type of a system bus or other data and command transfer system that couples the various components within the device. A system bus can include any one or combination of different bus structures and architectures, as well as control and data lines.

The device 600 also includes computer-readable storage memory devices 610 that enable one or both of data and instruction storage thereon, such as data storage devices that can be accessed by a computing device, and that provide persistent storage of data and executable instructions (e.g., software applications, programs, functions, and the like). Examples of the computer-readable storage memory devices 610 include volatile memory and non volatile memory, fixed and removable media devices, and any suitable memory device or electronic data storage that maintains data for computing device access. The computer-readable storage memory can include various implementations of random access memory (RAM), read only memory (ROM), flash memory, and other types of storage media in various memory device configurations. The device 600 may also include a mass storage media device.

The computer-readable storage memory device 610 provides data storage mechanisms to store the device data 612, other types of information or data (e.g., fingerprint data 112 and digital keys 114), and various device applications 614 (e.g., software applications). For example, an operating system 616 can be maintained as software instructions with a memory device and executed by the processing system 606 to cause the processing system 606 to perform various acts. The device applications 614 may also include a device manager, such as any form of a control application, software application, signal-processing and control module, code that is native to a particular device, a hardware abstraction layer for a particular device, and so on.

The device 600 can also include one or more device sensors 618, such as any one or more of an ambient light sensor, a proximity sensor, a touch sensor, an infrared (IR) sensor, accelerometer, gyroscope, thermal sensor, audio sensor (e.g., microphone), and the like. The device 600 can also include one or more power sources 620, such as when the device 600 is implemented as a mobile device. The power sources 620 may include a charging or power system, and can be implemented as a flexible strip battery, a rechargeable battery, a charged super-capacitor, or any other type of active or passive power source.

The device 600 additionally includes an audio or video processing system 622 that generates one or both of audio data for an audio system 624 and display data for a display system 626. In accordance with some embodiments, the audio/video processing system 622 is configured to receive call audio data from the transceiver 604 and communicate the call audio data to the audio system 624 for playback at the device 600. The audio system or the display system may include any devices that process, display, or otherwise render audio, video, display, or image data. Display data and audio signals can be communicated to an audio component or to a display component, respectively, via an RF (radio frequency) link, S-video link, HDMI (high-definition multimedia interface), composite video link, component video link, DVI (digital video interface), analog audio connection, or other similar communication link. In implementations, the audio system or the display system are integrated components of the example device. Alternatively, the audio system or the display system are external, peripheral components to the example device.

Although embodiments of techniques for biometric-based initialization of device ranging for digital key exchanges have been described in language specific to features or methods, the subject of the appended claims is not necessarily limited to the specific features or methods described. Rather, the specific features and methods are disclosed as example implementations of techniques for implementing image-based device customization for multiple users. Further, various different embodiments are described, and it is to be appreciated that each described embodiment can be implemented independently or in connection with one or more other described embodiments. Additional aspects of the techniques, features, and/or methods discussed herein relate to one or more of the following:

In some aspects, the techniques described herein relate to a mobile device comprising a memory, and one or more processors coupled with the memory and configured to cause the mobile device to receive, via a fingerprint sensor, authentication data during a touch event and, in response to successful authentication of the authentication data, perform device ranging in association with a digital key exchange with a secured area.

In some aspects, the techniques described herein relate to a mobile device wherein the authentication data is first authentication data received during a first touch event, the first authentication data being associated with a first finger associated with the digital key exchange with a first secured area.

In some aspects, the techniques described herein relate to a mobile device wherein the one or more processors are further configured to cause the mobile device to, in response to the mobile device being in a locked state and in response to the successful authentication of the first authentication data, enter an unlocked state and perform the device ranging in association with the digital key exchange with the first secured area.

In some aspects, the techniques described herein relate to a mobile device wherein the one or more processors are further configured to cause the mobile device to receive, via the fingerprint sensor, second authentication data during a second touch event, the second authentication data being associated with a second finger associated with granting access to the mobile device, the second finger not being associated with the digital key exchange with the first secured area and, in response to the mobile device being in a locked state and in response to the successful authentication of the second authentication data, enter an unlocked state and not initiate the device ranging in association with the digital key exchange with the first secured area.

In some aspects, the techniques described herein relate to a mobile device wherein the one or more processors are further configured to cause the mobile device to, in response to the mobile device being in an unlocked state and in response to the successful authentication of the authentication data, perform the device ranging in association with the digital key exchange with the first secured area.

In some aspects, the techniques described herein relate to a mobile device wherein the one or more processors are further configured to cause the mobile device to receive the authentication data after the touch event occurs for a time duration longer than a predetermined time threshold in response to the mobile device being in the unlocked state.

In some aspects, the techniques described herein relate to a mobile device wherein the authentication data is associated with a first finger associated with granting access to the mobile device, the first finger not being associated with the digital key exchange with the secured area, and the one or more processors are further configured to cause the mobile device to, in response to the mobile device being in a locked state and in response to successful authentication of the authentication data, enter an unlocked state and not initiate the device ranging in association with the digital key exchange with the secured area; receive, via the fingerprint sensor, second authentication data during a second touch event, the second authentication data being associated with the first finger and, in response to the mobile device being in the unlocked state and in response to the successful authentication of the second authentication data, initiate the device ranging in association with the digital key exchange with the secured area.

In some aspects, the techniques described herein relate to a mobile device wherein the one or more processors are further configured to cause the mobile device to receive the second authentication data after the second touch event occurs for a time duration longer than a predetermined time threshold in response to the mobile device being in the unlocked state.

In some aspects, the techniques described herein relate to a mobile device wherein the one or more processors are further configured to cause the mobile device to, in response to the device ranging indicating that the mobile device is within a predetermined distance of the secured area, transmit a digital key associated with the secured area to a receiver associated with the secured area to unlock the secured area.

In some aspects, the techniques described herein relate to a mobile device wherein the secured area comprises an automobile, a lock, a locker, a security system, a hotel room, or a smart home device.

In some aspects, the techniques described herein relate to a mobile device wherein the mobile device comprises a smartphone, a mobile phone, or a smartwatch.

In some aspects, the techniques described herein relate to a method comprising receiving, via a fingerprint sensor of a mobile device, authentication data during a touch event and, in response to successfully authenticating the authentication data, perform device ranging in association with a digital key exchange with a secured area.

In some aspects, the techniques described herein relate to a method wherein the authentication data is first authentication data received during a first touch event, the first authentication data being associated with a first finger associated with the digital key exchange with a first secured area.

In some aspects, the techniques described herein relate to a method wherein the method further comprises, in response to the mobile device being in a locked state and in response to successfully authenticating the first authentication data, entering an unlocked state and performing the device ranging in association with the digital key exchange with the first secured area.

In some aspects, the techniques described herein relate to a method wherein the method further comprises receiving, via the fingerprint sensor, second authentication data during a second touch event, the second authentication data being associated with a second finger associated with granting access to the mobile device, the second finger not being associated with the digital key exchange with the first secured area and, in response to the mobile device being in a locked state and in response to successfully authenticating the second authentication data, entering an unlocked state and not initiating the device ranging in association with the digital key exchange with the first secured area or, in response to the mobile device being in an unlocked state and in response to successfully authenticating the authentication data, performing the device ranging in association with the digital key exchange with the first secured area.

In some aspects, the techniques described herein relate to a method wherein the method further comprises receiving the authentication data after the touch event occurs for a time duration longer than a predetermined time threshold in response to the mobile device being in the unlocked state.

In some aspects, the techniques described herein relate to a method wherein the authentication data is associated with a first finger associated with granting access to the mobile device, the first finger not being associated with the digital key exchange with the secured area, and the method further comprises, in response to the mobile device being in a locked state and in response to successfully authenticating the authentication data, entering an unlocked state and not initiating the device ranging in association with the digital key exchange with the secured area, receiving, via the fingerprint sensor, second authentication data during a second touch event, the second authentication data being associated with the first finger and, in response to the mobile device being in the unlocked state and in response to successfully authenticating the second authentication data, initiating the device ranging in association with the digital key exchange with the secured area.

In some aspects, the techniques described herein relate to a method wherein the method further comprises receiving the second authentication data after the second touch event occurs for a time duration longer than a predetermined time threshold in response to the mobile device being in the unlocked state.

In some aspects, the techniques described herein relate to a method wherein the method further comprises, in response to the device ranging indicating that the mobile device is within a predetermined distance of the secured area, transmitting a digital key associated with the secured area to a receiver associated with the secured area to unlock the secured area.

In some aspects, the techniques described herein relate to a system comprising at least one memory and at least one processor coupled with the at least one memory and configured to cause the system to receive, via a fingerprint sensor, authentication data during a touch event and, in response to successful authentication of the authentication data, perform device ranging in association with a digital key exchange with a secured area.

1. A mobile device comprising:
a memory; and
one or more processors coupled with the memory and configured to cause the mobile device to:
receive, via a fingerprint sensor, authentication data during a touch event; and
in response to successful authentication of the authentication data, perform device ranging in association with a digital key exchange with a secured area.

2. The mobile device of claim 1, wherein:
the authentication data is first authentication data received during a first touch event, the first authentication data being associated with a first finger associated with the digital key exchange with a first secured area.

3. The mobile device of claim 2, wherein the one or more processors are further configured to cause the mobile device to:
in response to the mobile device being in a locked state and in response to the successful authentication of the first authentication data, enter an unlocked state and perform the device ranging in association with the digital key exchange with the first secured area.

4. The mobile device of claim 2, wherein the one or more processors are further configured to cause the mobile device to:
receive, via the fingerprint sensor, second authentication data during a second touch event, the second authentication data being associated with a second finger associated with granting access to the mobile device, the second finger not being associated with the digital key exchange with the first secured area; and
in response to the mobile device being in a locked state and in response to the successful authentication of the second authentication data, enter an unlocked state and not initiate the device ranging in association with the digital key exchange with the first secured area.

5. The mobile device of claim 2, wherein the one or more processors are further configured to cause the mobile device to:
in response to the mobile device being in an unlocked state and in response to the successful authentication of the authentication data, perform the device ranging in association with the digital key exchange with the first secured area.

6. The mobile device of claim 5, wherein the one or more processors are further configured to cause the mobile device to receive the authentication data after the touch event occurs for a time duration longer than a predetermined time threshold in response to the mobile device being in the unlocked state.

7. The mobile device of claim 1, wherein:
the authentication data is associated with a first finger associated with granting access to the mobile device, the first finger not being associated with the digital key exchange with the secured area; and
the one or more processors are further configured to cause the mobile device to:
in response to the mobile device being in a locked state and in response to successful authentication of the authentication data, enter an unlocked state and not initiate the device ranging in association with the digital key exchange with the secured area;
receive, via the fingerprint sensor, second authentication data during a second touch event, the second authentication data being associated with the first finger; and
in response to the mobile device being in the unlocked state and in response to the successful authentication of the second authentication data, initiate the device ranging in association with the digital key exchange with the secured area.

8. The mobile device of claim 7, wherein the one or more processors are further configured to cause the mobile device to receive the second authentication data after the second touch event occurs for a time duration longer than a predetermined time threshold in response to the mobile device being in the unlocked state.

9. The mobile device of claim 1, wherein the one or more processors are further configured to cause the mobile device to:
in response to the device ranging indicating that the mobile device is within a predetermined distance of the secured area, transmit a digital key associated with the secured area to a receiver associated with the secured area to unlock the secured area.

10. The mobile device of claim 1, wherein the secured area comprises an automobile, a lock, a locker, a security system, a hotel room, or a smart home device.

11. The mobile device of claim 1, wherein the mobile device comprises a smartphone, a mobile phone, or a smartwatch.

12. A method comprising:
receiving, via a fingerprint sensor of a mobile device, authentication data during a touch event; and
in response to successfully authenticating the authentication data, perform device ranging in association with a digital key exchange with a secured area.

13. The method of claim 12, wherein:
the authentication data is first authentication data received during a first touch event, the first authentication data being associated with a first finger associated with the digital key exchange with a first secured area.

14. The method of claim 13, wherein the method further comprises:
in response to the mobile device being in a locked state and in response to successfully authenticating the first authentication data, entering an unlocked state and performing the device ranging in association with the digital key exchange with the first secured area.

15. The method of claim 13, wherein the method further comprises:
receiving, via the fingerprint sensor, second authentication data during a second touch event, the second authentication data being associated with a second finger associated with granting access to the mobile device, the second finger not being associated with the digital key exchange with the first secured area; and
in response to the mobile device being in a locked state and in response to successfully authenticating the second authentication data, entering an unlocked state and not initiating the device ranging in association with the digital key exchange with the first secured area; or
in response to the mobile device being in an unlocked state and in response to successfully authenticating the authentication data, performing the device ranging in association with the digital key exchange with the first secured area.

16. The method of claim 15, wherein the method further comprises receiving the authentication data after the touch event occurs for a time duration longer than a predetermined time threshold in response to the mobile device being in the unlocked state.

17. The method of claim 12, wherein:
the authentication data is associated with a first finger associated with granting access to the mobile device, the first finger not being associated with the digital key exchange with the secured area; and
the method further comprises:
in response to the mobile device being in a locked state and in response to successfully authenticating the authentication data, entering an unlocked state and not initiating the device ranging in association with the digital key exchange with the secured area;
receiving, via the fingerprint sensor, second authentication data during a second touch event, the second authentication data being associated with the first finger; and
in response to the mobile device being in the unlocked state and in response to successfully authenticating the second authentication data, initiating the device ranging in association with the digital key exchange with the secured area.

18. The method of claim 17, wherein the method further comprises receiving the second authentication data after the second touch event occurs for a time duration longer than a predetermined time threshold in response to the mobile device being in the unlocked state.

19. The method of claim 12, wherein the method further comprises, in response to the device ranging indicating that the mobile device is within a predetermined distance of the secured area, transmitting a digital key associated with the secured area to a receiver associated with the secured area to unlock the secured area.

20. A system comprising:
at least one memory; and
at least one processor coupled with the at least one memory and configured to cause the system to:
receive, via a fingerprint sensor, authentication data during a touch event; and
in response to successful authentication of the authentication data, perform device ranging in association with a digital key exchange with a secured area.
